(19) United States
(12) Patent Application Publication
(10) Pub. No.: US 2014/0188296 A1
(43) Pub. Date: Jul. 3, 2014

(54) METHOD FOR CONTROLLING LOAD

(71) Applicants: Jung Hwan Oh, Seoul (KR); Jae Seong Park, Daejeon Metropolitan City (KR); Se Young Lee, Anyang-si (KR)

(72) Inventors: Jung Hwan Oh, Seoul (KR); Jae Seong Park, Daejeon Metropolitan City (KR); Se Young Lee, Anyang-si (KR)

(73) Assignee: LSIS CO., LTD., Anyang-si, Gyeonggi-do (KR)

(21) Appl. No.: 13/992,694

(22) PCT Filed: Nov. 25, 2011
(86) PCT No.: PCT/KR2011/009051

§ 371 Date: Dec. 4, 2013

(30) Foreign Application Priority Data
Dec. 9, 2010 (KR) 10-2010-0125794

(51) Int. Cl. H02J 4/00

(52) U.S. Cl. CPC H02J 4/00
USPC 700/295

(57) ABSTRACT

According to the present invention, a method for controlling a load comprises the steps of: receiving, from a host device, a load control message for controlling at least one or more load devices; transmitting a load control command to the at least one or more load devices, on the basis of at least one of said load control message, state information of the load devices and, a preset load control condition; and transmitting, to said host device or an external device, a response message that includes information indicative of a load control state in response to said load control message.

### TECHNICAL FIELD

The present invention relates to load control method, and more particularly to a load control method configured to effectively perform a power management function to load devices in a customer location.

### BACKGROUND ART

Electric power consumption is on the rise in various fields. Particularly, occasions may arise where electric power consumption momentarily increases per season and per region to create a problem to electric power demand in social infrastructure that must be essentially maintained. In hot summer days particularly, phenomenon often occurs where the electric demand temporarily surges due to sudden increase in use of air conditioners.

In a case the electric power consumption surpasses useable supply capacity; power grid may suffer from fatal damages regardless of power consumption region and power consumption facility. Thus, in a case the power consumption surpasses the supply capacity, power supply supplied to all users may be automatically and indiscriminately interrupted in order to prevent the power grid from being damaged, or a black-out, a large scale power supply interruption, may occur where power supply is temporarily stopped to a selected area.

Therefore, there is a need to adequately adjust the power consumption at a user side in order to prevent the black-out from occurring.

### DISCLOSURE

### Technical Problem

The present invention is provided to solve the aforementioned problems and the present invention provides a load control method configured to provide a load control message for controlling a power load, whereby power load on load devices in a customer location can be effectively controller.

### Technical Solution

In one general aspect of the present disclosure, there may be provided a load control method, the method comprising: a) receiving, from a host device, a load control message for controlling at least one load device; b) transmitting a load control command to the at least one load device, based on at least one of the load control message, state information of the load device and a preset load control condition; and c) transmitting a response message comprising information indicating load control state to the host device or an outside device in response to the load control message, wherein the state information of the load device includes any one of contact state, non-contact state and keep state.

In some exemplary embodiments of the present disclosure, the load control message may comprise identity information identifying at least one load device, and control information controlling a load of the load device corresponding to the identity information, wherein the load control command is the load control message or includes the load control message.

In some exemplary embodiments of the present disclosure, the load control message may comprise at least one of an ON-time section of the load device, OFF-time section, and information controlling an operation subsequent to a predetermined time after receipt of message.

In some exemplary embodiments of the present disclosure, the load control command may include a command controlling an activation switch of the load device.

In some exemplary embodiments of the present disclosure, the c) step may include transmitting the response message including information indicating the load control state in response to a request from the hose device or the outside device.

In some exemplary embodiments of the present disclosure, the preset load control condition may be to activate the at least one load device when price information does not surpass a particular value.

In some exemplary embodiments of the present disclosure, the preset load control condition may be to activate the at least one load device in association with an electricity rate.

In some exemplary embodiments of the present disclosure, the preset load control condition may be to activate the load of the load device in adaptive response to amount of consumed electricity.

In some exemplary embodiments of the present disclosure, the keep state of the load device may be to keep the contact state when previous state information is in a contact state and to keep the non-contact state when the previous state information is in a non-contact state.

In another general aspect of the present disclosure, there may be provided a load control method, the method comprising: a) from a host device, a load control message for controlling at least one load device; b) generating a load control command for load control of the load device, based on at least one of the load control message, state information of the load device and a preset load control condition; and c) performing load control of the load device in response to the load control command, wherein the load control message comprises identity information identifying the load device and control information controlling a load of the load device corresponding to the identity information.

In some exemplary embodiments of the present disclosure, the load control message may comprise at least one of an ON-time section of the load device, OFF-time section, and information controlling an operation subsequent to a predetermined time after receipt of message.

In some exemplary embodiments of the present disclosure, the load control method may further comprise d) transmitting a response message comprising information indicating load control state of the load device in response to request of the host device.

In some exemplary embodiments of the present disclosure, the preset load control condition may be to activate the at least one load device when price information does not surpass a particular value.

In some exemplary embodiments of the present disclosure, the preset load control condition may be to activate the at least one load device in association with an electricity rate.

In some exemplary embodiments of the present disclosure, the preset load control condition may be to activate the load of the load device in adaptive response to amount of consumed electricity.

In some exemplary embodiments of the present disclosure, the load control may include a power control of the load device.

In some exemplary embodiments of the present disclosure, the power control of the load device may be performed by controlling an output terminal disposed inside a device receiving the load control message.

In some exemplary embodiments of the present disclosure, the power control of the load device may be performed by transmitting the load control command to a power control outside device configured to control a power of the load.

In some exemplary embodiments of the present disclosure, the power control of the load device may be such that a power-OFF is realized by a remote communication and a power-ON may be realized by a remote communication or manually on the spot.

In some exemplary embodiments of the present disclosure, the load control may be to control electricity (amount) consumed by the load device based on any one of a real-time power consumption used by the load device, a time-varying power and price information.

### Advantageous Effects

The load control method according to the exemplary embodiments of the present disclosure has an advantageous effect in that a user can institutively recognize a gain of load control command to enhance efficiency of a load control system, and user participation can be more easily induced by notifying the user information on load control on utility position. Another advantageous effect is that utility can deactivate or activate a load based on interruption/connection time and energy price to expect a stable operation on energy management side by performing a planned energy supply.

### DESCRIPTION OF DRAWINGS

FIG. 1 is a block diagram illustrating a system for power load control according to an exemplary embodiment of the present disclosure.

FIG. 2 is a flowchart illustrating a load control method according to an exemplary embodiment of the present disclosure.

FIG. 3 is a schematic view illustrating a field configuration of a load control message according to an exemplary embodiment of the present disclosure.

### BEST MODE

Advantages and features of the present disclosure may be understood more readily by reference to the following detailed description of exemplary embodiments and the accompanying drawings. Detailed descriptions of well-known functions, configurations or constructions are omitted for brevity and clarity so as not to obscure the description of the present disclosure with unnecessary detail.

Hereinafter, the load control method according to exemplary embodiments will be described more fully hereinafter with reference to the accompanying drawings.

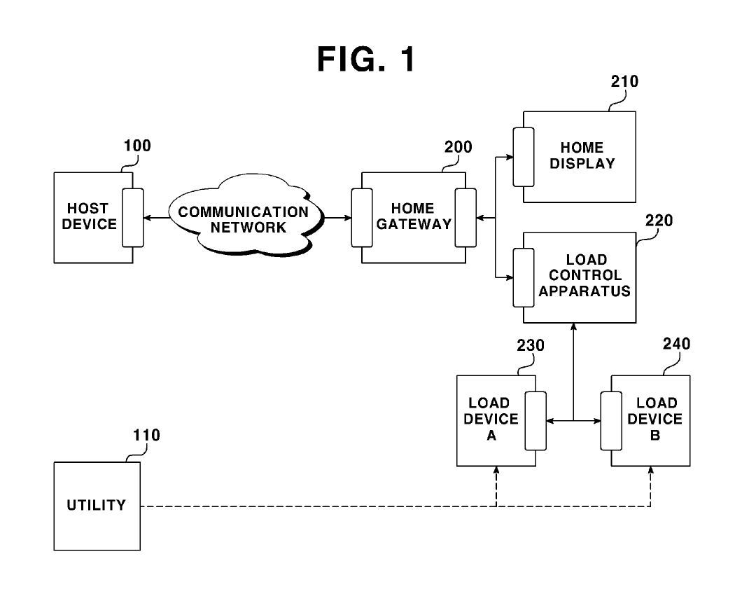

FIG. 1 is a block diagram illustrating a system for power load control according to an exemplary embodiment of the present disclosure.

Referring to FIG. 1, a power load control system according to an exemplary embodiment of the present disclosure comprises a host device 100, a load control device 220 and a home display 210. The host device 100 and the load control device 220 may be connected to a wireless or wired communication network through a home gateway 200, and the home gateway 200 may be integrated with function of the load control device 220. The home display 210 may be integrated or separately formed with load devices 230 and 240 or a load control device 220, and may be a mobile device.

The host device 100 may be a load control server mounted at a utility 100 or management and service provider side supplying a power as an outside device to control a power load. The host device 100 may be a device formed with a typical hardware or software performing a hose process, and may classify a power load to various regions.

The hose device 100 may be mounted with a database including addresses of extensive regions other necessary information for collecting and managing power load related information of a relevant region. Furthermore, the host process of the host device 100 may control a power load relative to an entire region supplying power, and may include other functions for controlling the power load.

The host device 100 and the home gateway 200 are connected to a communication network such as Internet. The communication network may be generally a super highway communication network. Furthermore, although the home gateway 200 can mutually connect or relay subscriber access network, the home gateway 200 may be performed as a home server having various server functions configured to provide multimedia functions by adding middleware to upper layer. Furthermore, in another exemplary embodiment, the home gateway 200 may perform only a gateway function for communicating with an outside communication network, and the load control device 220 may be realized to operate as a home server.

In still another exemplary embodiment, the load control device 220 may be installed inside a meter of consumer. In this case, the meter may include a separate message receiving device, and the load control device may manage load devices in response to a control message received from the message receiving device.

Meantime, load devices A and B (230 and 240) may be various devices consuming an electric power such as refrigerators, heaters and display devices actually consuming the power inside a house or an office. That is, the load devices A and B (230 and 240) may include most of devices consuming the power inside a consumer house.

The load devices A and B (230 and 240) may be connected to an IHD (In-Home Display) 210 or the load control device 220. In another exemplary embodiment, each of the load devices A and B (230 and 240) may be separately connected with the IHD 210 and the load control device 220.

Now, the load control method according to exemplary embodiments of the present disclosure thus configured will be described.

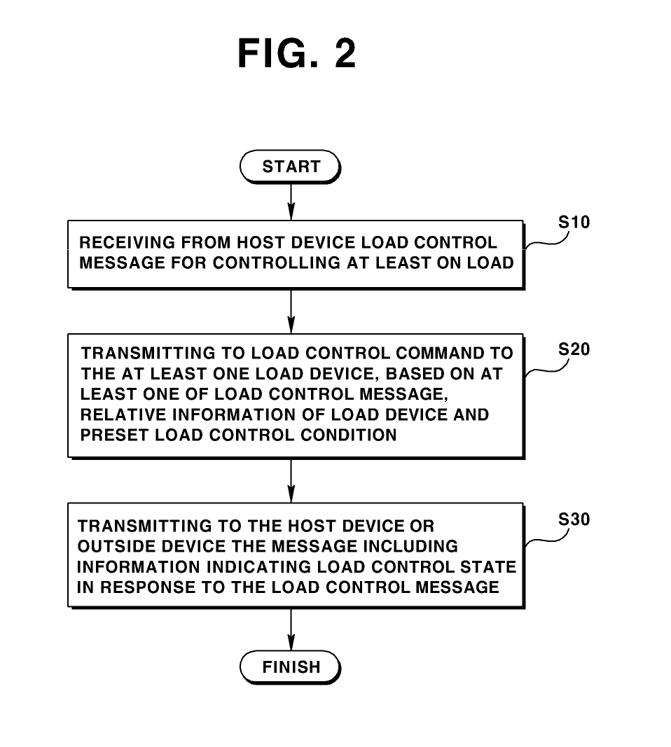

FIG. 2 is a flowchart illustrating a load control method according to an exemplary embodiment of the present disclosure. Referring to FIG. 2, the power load control method according to exemplary embodiment of the present disclosure comprises performing a step (S10) receiving, by the load control device 220, from the host device, a load control message for controlling at least one load. The load control device 220 may be a device separately installed for controlling the load devices 230 and 240, or a device integrated with a load device.

Now, the load control message will be described in more detail.

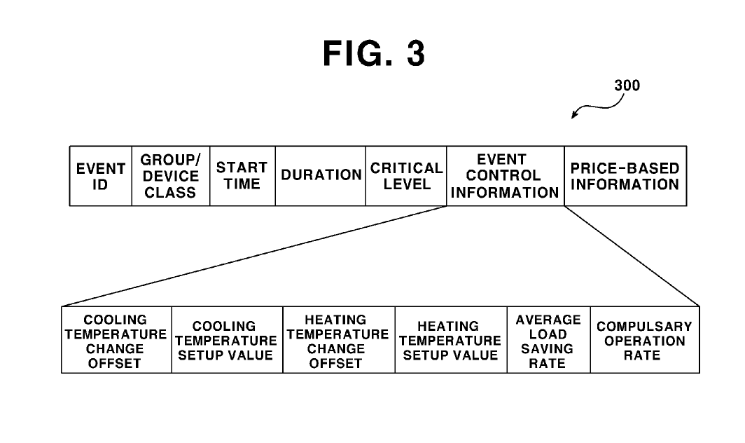

FIG. 3 is a schematic view illustrating a field configuration of a load control message 300 according to an exemplary embodiment of the present disclosure. Referring to FIG. 3, the load control message 300 includes a group/device class indicating an event ID, a particular group or a type of a particular load device, a start time for starting an event performance, a duration indicating an event performance period, a critical level indicating urgency of the event, event control information indicating control content of the event, and price based information obtained during execution of the event.

The event control information may vary in response to the group/device class. For example, in a case the group/device class indicates a load device of a particular type or a particular load device, information of ON time section of the load device, information of OFF time section, information on repetitive cycle, and information for controlling operations subsequent to a predetermined time after receipt of a message may be selectively included as control information for controlling a load of the load device.

Furthermore, the event control information may selectively comprise various items for detailed event control (e.g., cooling temperature change offset, cooling temperature set-up value, a heating temperature offset, a heating temperature set-up value), an average load saving rate and a compulsory operation rate, where the cooling temperature change offset notifies to what degree a cooling temperature is to be changed from a currently set temperature, and notifies that the cooling temperature set-up value sets the cooling temperature at this temperature. The heating temperature change offset and the heating temperature set-up value also perform the same function relative to the heating temperature. The average load saving rate indicates that an average load amount versus currently used load amount is controlled by a degree corresponding to this value (%). The compulsory operation rate is a value indicated by percentage for a period that must be essentially operated in entire load control duration.

The price based information may be information indicating a rate level corresponding to an energy rate saved when a load control inside the load control message is performed, or a rate corresponding to the saved rate. Furthermore, the price based information may comprise dynamic rate information that changes in time.

The critical level indicating urgency of an event may comprise various levels. For example, the critical level may include several levels each having low urgency, an emergency level indicating urgency, an outage level indicating an anticipated outage and a forced outage level (disconnect level).

Next, the load control device 220 performs a step (S20) transmitting a load control command to the load devices 230, 240 of at least one consumer house based on at least one of the received load control message 300, state information of the load devices 230 and 240 of a consumer house and a preset load control condition, in a case the load control message 300 is received.

The load control command may be a command controlling switches of the load devices 230, 240. Furthermore, the load control device 220 performs a load control of corresponding load devices 230, 240 in response to load control command.

The load control by the load device may be to control the power of the load device. The power control by the load device may be to control an output terminal mounted inside the load control device having received the load control message 300. In this case, supply of power to the load device may be performed through the output terminal of the load control device, and in a case the output terminal of the load control device is OFF, the power supplied to the load device may be interrupted (OFF). The output terminal may be a contactor.

Furthermore, the power control of the load device may be realized by transmittance of a load control command to an outside power control device. The outside power control device may be a switch or a contactor, for example.

The load control method of the load device may include at least one of methods of controlling an ON time section of the load device, an OFF time section and an operation subsequent to a predetermined time after receipt of the load control message.

All of the power OFF and ON of the load device may be remotely realized via communication. That is, the power OFF may be remotely realized via communication and the power ON may be directly realized on the spot by an operator via communication.

The load control method of the load device may be to control a power (amount) consumed in the load device based on at least one of a real-time power consumption used by the load device and time-variable power price information.

Furthermore, the state information of the load devices 230 and 240 may be a contact state or a non-contact state between the load devices 230 and 240 and a power line. If necessary, a keep state may be added. The load control state of the load devices 230 and 240 may be displayed on the home display 210, and may be displayed on an outside user device if so set up by a user. At this time, the keep state of the load devices 230 and 240 keeps a keep state in a case previous state information is in a contact state, and keeps a non-keep state in a case previous state information is in a non-contact state, or may be in a preparation state for contact.

Furthermore, the preset load control condition may be a condition pre-inputted by a user, and may be a price-based condition. For example, in a case the load control message includes the price-based information, the condition may be a condition activating the load devices 230 and 240 in a case the price-based information corresponding thereto does not surpass a particular value. Furthermore, the preset load control condition may be a condition adaptively activating the loads of the load devices 230 and 240 in association with the power tariff or power rate, or a condition adaptively activating the loads of the load devices 230 and 240 in response to consumed accumulated power value. Furthermore, the preset load control condition may include critical level information indicating execution of setup condition other than setup condition.

Hereinafter, steps for transmitting a load control command of the load control device 220 will be described in more detail.

The load control device 220 analyzes critical information indicating urgency of the received load control message 300. In a case the critical information indicating the urgency indicates a low-urgency level, determination is made as to whether information to be compared with the preset load control condition is included in the load control message. In a case the preset load control condition and the information to be compared are included in the load control message, the preset load control condition and the information contained in the load control message are compared and determination is made as to whether to deactivate the load of corresponding load device. Furthermore, a determination is made as to whether to generate a command for controlling a load of the load device with reference to current load state information of the load device. At this time, in a case the preset load control condition is the price-based information, the price-based information included in the load control message and price-base information of the preset load removal condition are compared.

In a case the information to be compared with the preset load control condition is not included in the load control message, and in a case the preset load control condition is to be performed on a priority base, determination is made as to whether to deactivate the load of the load device in response to the preset load control condition.

Meanwhile, in a case the critical information indicating urgency of the received load control message 300 is a critical level indicating urgency, comparison may be made with the critical level information contained in the preset load control condition to selectively determine whether to deactivate the load of the load device. However, in a case the preset load control condition is not contained with the critical level information, a determination is made as to whether to generate a control command for performing the load control based on the received load control message and the state information of the corresponding load device.

In a case the critical information indicating urgency of the received load control message 300 is an outage level indicating an anticipated outage or a forced outage (disconnect) level, a load control is performed in response to the load control message regardless of the preset load control condition.

Successively, the load control device 220, in response to the load control message of the host device (or outside device), transmits a response message including information indicating the load control condition to the host device 100 (S30).

At this time, the response message may include other response contents in response to event control information indicating an event ID of the load control message or control contents of the event. For example, response may be responded in the form of “YES” or “NO” in response to the event control information, and may be responded with information indicating execution percentage.

Meanwhile, an indicating step on the home display 210 may be performed in order for a user to visually recognize information on the load control state of the load devices A, B 230, 240 and the load control state of the load control device 220.

### INDUSTRIAL APPLICABILITY

In an advantageous aspect, the load control method according to the exemplary embodiments of the present disclosure is such that a user can institutively recognize a gain of load control command to further enhance efficiency of a load control on the load devices 230, 240, and a user participation to the load control command can be more easily induced by notifying information on load control on the position of utility 110 as a power supplier. In another advantageous aspect, load can be deactivated or activated based on interruption/connection time and energy price to expect a stable operation on energy system management side by performing a planned energy supply.

Although the present disclosure has been described with reference to a number of illustrative embodiments thereof, it should be understood that numerous other modifications and embodiments can be devised by those skilled in the art that will fall within the spirit and scope of the principles of this disclosure.

1. A load control method, the method comprising:
a) receiving, from a host device, a load control message for controlling at least one load device;
b) transmitting a load control command to the at least one load device, based on at least one of the load control message, state information of the load device and a preset load control condition; and
c) transmitting a response message comprising information indicating load control state to the host device or an outside device in response to the load control message, wherein the state information of the load device includes any one of contact state, non-contact state and keep state.

2. The load control method of claim 1, wherein the load control message comprises identity information identifying at least one load device, and control information controlling a load of the load device corresponding to the identity information, wherein the load control command is the load control message or includes the load control message.

3. The load control method of claim 1, wherein the load control message comprises at least one of an ON-time section of the load device, OFF-time section, and information controlling an operation subsequent to a predetermined time after receipt of message.

4. The load control method of claim 1, wherein the load control command includes a command controlling an activation switch of the load device.

5. The load control method of claim 1, wherein the c) step includes transmitting the response message including information indicating the load control state in response to a request from the hose device or the outside device.

6. The load control method of claim 1, wherein the preset load control condition is to activate the at least one load device when price information does not surpass a particular value.

7. The load control method of claim 1, wherein the preset load control condition is to activate the at least one load device in association with an electricity rate.

8. The load control method of claim 1, wherein the preset load control condition is to activate the load of the load device in adaptive response to amount of consumed electricity.

9. The load control method of claim 1, wherein the keep state of the load device is to keep the contact state when previous state information is in a contact state and to keep the non-contact state when the previous state information is in a non-contact state.

10. A load control method, the method comprising:
a) from a host device, a load control message for controlling at least one load device;
b) generating a load control command for load control of the load device, based on at least one of the load control message, state information of the load device and a preset load control condition; and
c) performing load control of the load device in response to the load control command, wherein the load control message comprises identity information identifying the load device and control information controlling a load of the load device corresponding to the identity information.

11. The load control method of claim 10, wherein the load control message comprises at least one of an ON-time section of the load device, OFF-time section, and information controlling an operation subsequent to a predetermined time after receipt of message.

12. The load control method of claim 10, further comprising:
d) transmitting a response message comprising information indicating load control state of the load device in response to request of the host device.

13. The load control method of claim 10, wherein the preset load control condition is to activate the at least one load device when price information does not surpass a particular value.

14. The load control method of claim 10, wherein the preset load control condition is to activate the at least one load device in association with an electricity rate.

15. The load control method of claim 10, wherein the preset load control condition is to activate the load of the load device in adaptive response to amount of consumed electricity.

16. The load control method of claim 10, wherein the load control includes a power control of the load device.

17. The load control method of claim 16, wherein the power control of the load device is performed by controlling an output terminal disposed inside a device receiving the load control message.

18. The load control method of claim 16, wherein the power control of the load device is performed by transmitting the load control command to a power control outside device configured to control a power of the load.

19. The load control method of claim 16, wherein the power control of the load device is such that a power-OFF is realized by a remote communication and a power-ON is realized by a remote communication or manually on the spot.

20. The load control method of claim 16, wherein the load control is to control electricity (amount) consumed by the load device based on any one of a real-time power consumption used by the load device, a time-varying power and price information.
